(19) United States
(12) Patent Application Publication
(10) Pub. No.: US 2011/0121670 A1
(43) Pub. Date: May 26, 2011

(54) FLUID COOLED ELECTRIC MOTOR

(76) Inventors: Xin-Yi WU, Tainan City (TW); Chia-Hung CHIEN, New Taipei City (TW)

(21) Appl. No.: 12/951,427

(22) Filed: Nov. 22, 2010

(30) Foreign Application Priority Data
Nov. 23, 2009 (TW) 098139707

(51) Int. Cl. H02K 9/04; H02K 9/06

(52) U.S. Cl. 310/59

(57) ABSTRACT

An electric motor includes a stator fixed in a motor housing, disposed around a motor shaft rotatable relative to the motor housing and formed with a radially extending through hole that is in spatial communication with an air-flow space defined between the stator and a tube body of the motor housing. The tube body is formed with an annular fluid-flow channel for receiving cooling fluid therein. A rotor is sleeved fixedly on the motor shaft. The motor shaft co-rotates with the rotor. The rotor is formed with angularly spaced apart slots extending inwardly and radially from an outer annular surface thereof, and air holes extending from an end surface thereof in an axial direction. Each air hole in the rotor is in spatial communication with corresponding slots. When the rotor rotates, the through hole in the stator is successively in spatial communication with the slots in the rotor.

### CROSS-REFERENCE TO RELATED APPLICATION

This application claims priority of Taiwanese Application No. 098139707, filed on Nov. 23, 2009.

### BACKGROUND OF THE INVENTION

1. Field of the Invention

The invention relates to an electric motor, and more particularly, to a fluid cooled electric motor.

2. Description of the Related Art

FIG. 1 illustrates a conventional air cooled motor 1 that includes a motor shaft 11 co-rotatable with a rotor 13, and a fan impeller 12 mounted fixedly on the motor shaft 11 such that the fan impeller co-rotates with the motor shaft 11 to generate cooled air flow, which is guided by an open guiding shell 14, to thereby attain a heat dissipation effect. However, such a fan impeller 12 may generate noise during operation, and provides an inferior cooling effect when the guiding shell 14 contains too much dirt or when the ambient environment has a relatively high humidity.

Referring to FIG. 2, a conventional liquid cooled motor 2 disclosed in U.S. Pat. No. 5,859,482 includes a cooling conduit 21 formed in a stator frame 22. In use, a cooling medium, such as water, flows through the cooling conduit 21 to cool the motor 2 during operation. Such a cooling conduit 21 cannot effectively dissipate heat from a rotor (not shown) of the motor 2 during operation, thereby adversely affecting the service life of the motor 2.

### SUMMARY OF THE INVENTION

Therefore, an object of the present invention is to provide a fluid cooled electric motor that has an improved heat dissipation effect.

According to the present invention, an electric motor comprises:

a motor housing including a tube body, the tube body being formed with an annular fluid-flow channel adapted for receiving cooling fluid therein, and an inlet and an outlet in spatial communication with the fluid-flow channel, and having opposite inner and outer annular surfaces;

a motor shaft mounted rotatably within the motor housing and rotatable relative to the motor housing about a central axis of the tube body;

a stator mounted fixedly in the motor housing, disposed around the motor shaft, and cooperating with the tube body to define an air-flow space therebetween, the stator having an inner annular surface and an outer surrounding surface, and being formed with at least one through hole extending radially from the inner annular surface to the outer surrounding surface and in spatial communication with the air-flow space; and

a rotor sleeved fixedly on the motor shaft such that the motor shaft co-rotates with the rotor, the rotor having two end surfaces opposite to each other in an axial direction parallel to the central axis, and an outer annular surface, the outer annular surface of the rotor being formed with a plurality of inwardly and radially extending slots spaced angularly apart from each other, at least one of the end surfaces of the rotor being formed with a plurality of air holes spaced angularly apart from each other and extending in the axial direction, each of the air holes in the rotor being in spatial communication with at least a corresponding one of the slots.

When the rotor rotates, the through hole in the stator is successively in spatial communication with the slots in the rotor.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional air cooled motor;

FIG. 2 is a perspective view of a conventional liquid cooled motor;

FIG. 3 is an exploded perspective, partially cutaway view showing the first preferred embodiment of an electric motor according to the present invention;

FIG. 4 is a schematic sectional view of a stator of the first preferred embodiment taken along line VI-VI in FIG. 3;

FIG. 5 is a schematic section view of the stator of the first preferred embodiment taken along line V-V in FIG. 3;

FIG. 6 is a schematic side view showing a rotor of the first preferred embodiment;

FIG. 7 is a schematic sectional view of FIG. 6 taken along line VII-VII;

FIG. 8 is a schematic sectional view of FIG. 6 taken along line VIII-VIII;

FIG. 9 is a fragmentary perspective view showing the rotor of the first preferred embodiment;

FIG. 10 is a schematic sectional view showing the first preferred embodiment;

FIG. 11 is a schematic sectional view showing a variation of the first preferred embodiment;

FIG. 12 is a schematic sectional view showing the second preferred embodiment of an electric motor according to the present invention; and

FIG. 13 is a schematic sectional view showing the third preferred embodiment of an electric motor according to the present invention.

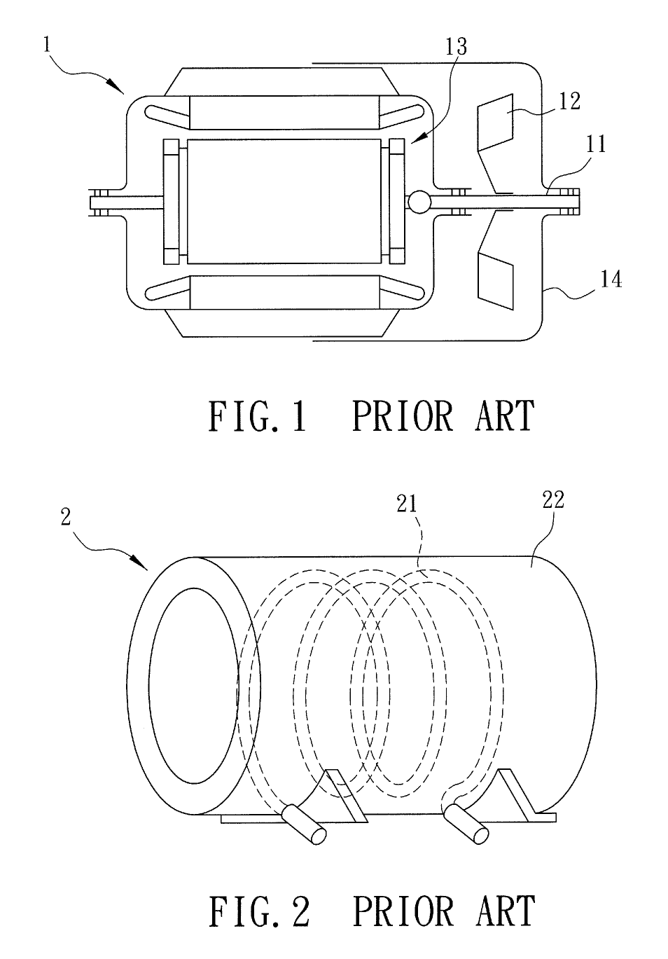

### DETAILED DESCRIPTION OF THE PREFERRED EMBODIMENTS

Before the present invention is described in greater detail, it should be noted that like elements are denoted by the same reference numerals throughout the disclosure.

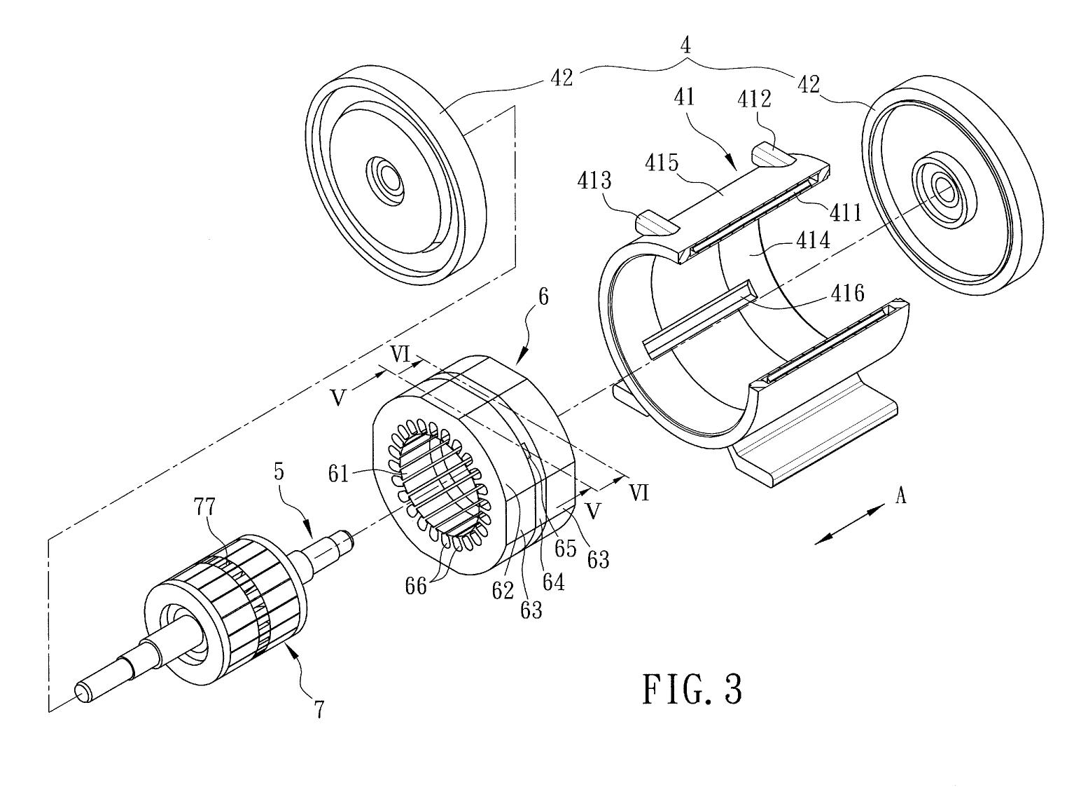

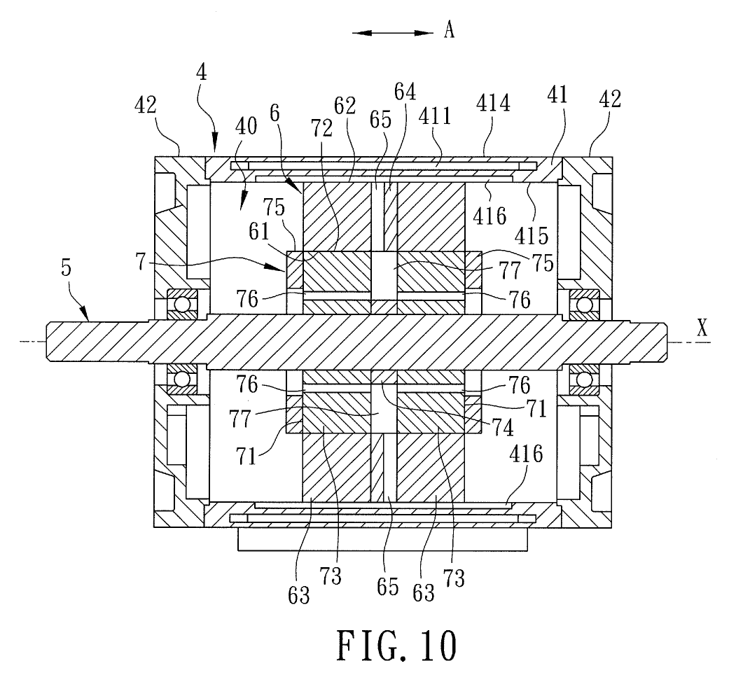

Referring to FIGS. 3 and 10, the first preferred embodiment of an electric motor according to the present invention is shown to include a motor housing 4, a motor shaft 5, a stator 6, and a rotor 7.

The motor housing 4 includes a tube body 41 and opposite cover bodies 42. The tube body 41 extends in an axial direction (A), and is formed with an annular fluid-flow channel 411 adapted for receiving cooling fluid, such as water, therein, and an inlet 412 and an outlet 413 that are in communication with the fluid-flow channel 411 and that are adapted to be connected to a fluid cycling system (not shown) for cycling the cooling fluid in the fluid-flow channel 411 through the inlet 412 and the outlet 413. The cover bodies 42 are mounted respectively on opposite ends of the tube body 41. The tube body 41 has opposite inner and outer annular surfaces 414, 415.

The motor shaft 5 is mounted rotatably within the motor housing 4, and is rotatable relative to the motor housing 4 about a central axis (X) of the tube body 41.

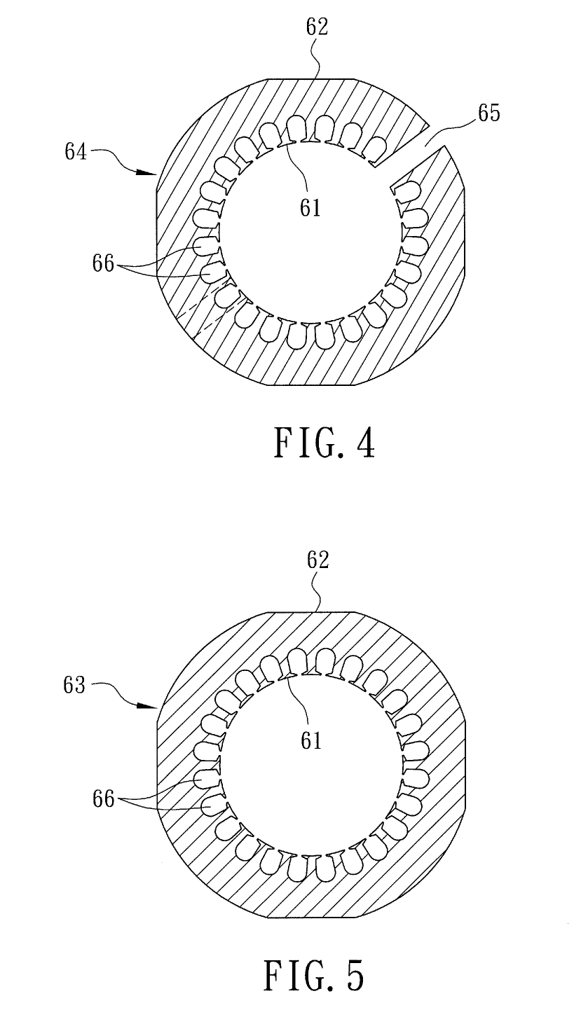

The stator 6 is mounted fixedly in the motor housing 4, is disposed around the motor shaft 5, and cooperates with the tube body 41 to define an air-flow space 40 therebetween. The stator 6 has an inner annular surface 61 and an outer surrounding surface 62, and is formed with opposite through holes 65 extending radially from the inner annular surface 61 to the outer surrounding surface 62 and in spatial communication with the air-flow space 40. In this embodiment, the air-flow space 40 includes opposite air grooves 416 formed in the inner annular surface 414 of the tube body 41 of the motor housing 4, extending in the axial direction (A), and in spatial communication with the through holes 65 in the stator 6, respectively, as shown in FIG. 10. The air grooves 416 have a length longer than that of the stator 6 in the axial direction (A), as shown in FIG. 10. In this embodiment, the stator 6 includes two first stator sections 63 opposite to each other in the axial direction (A), and a second stator section 64 interconnecting the first stator sections 63 and formed with the through holes 65. Each of the first and second stator sections 63, 64 consists of a plurality of silicon steel pieces (not shown). Referring to FIGS. 4 and 5, the inner annular surface 61 of the stator 6 is formed with a plurality of winding grooves 66 spaced angularly apart from each other and extending in the axial direction (A) through the first stator sections 63 and through the second stator section 64.

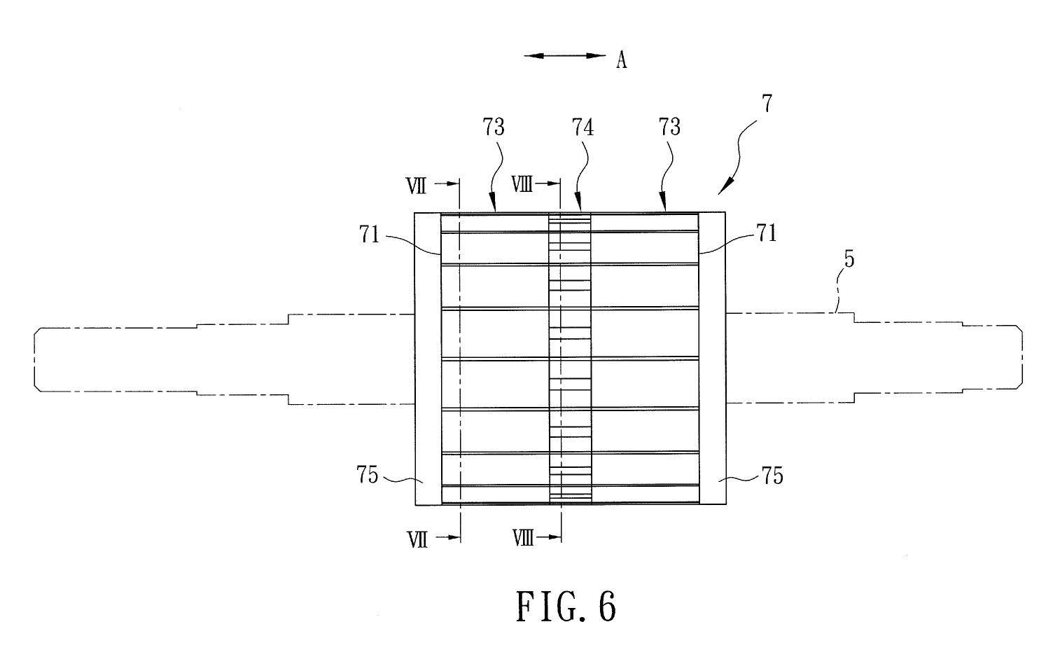

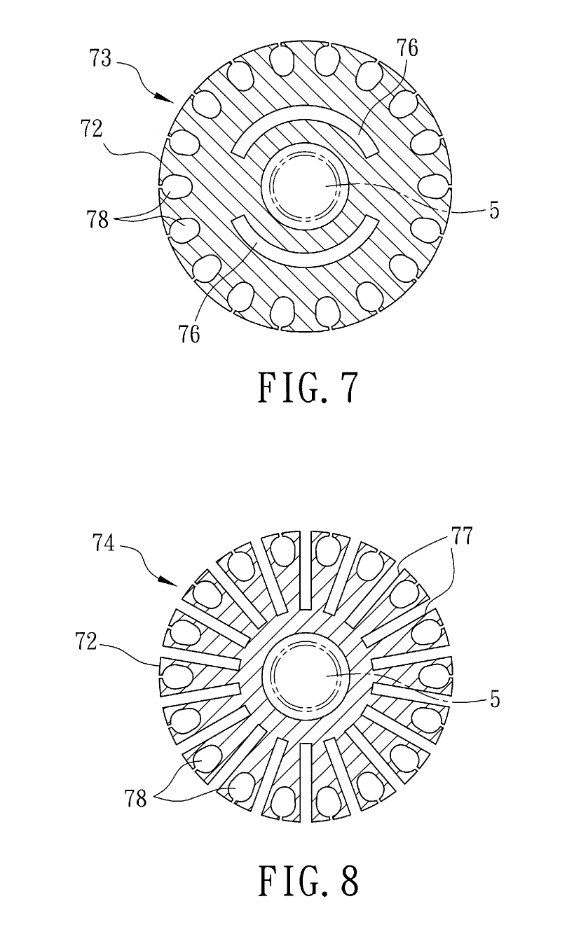

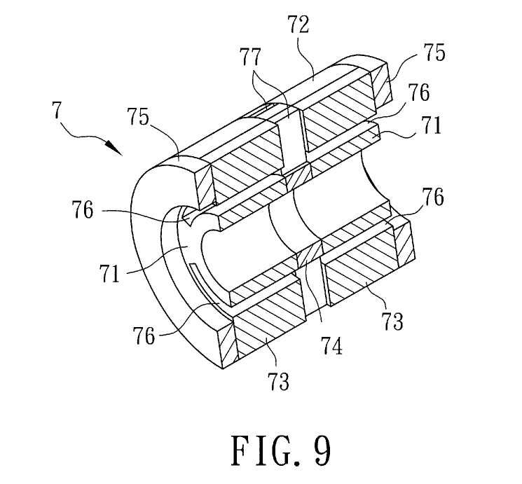

Referring further to FIGS. 6 to 9, the rotor 7 is sleeved fixedly on the motor shaft 5 such that the motor shaft 5 co-rotates with the rotor 7. The rotor 7 has two end surfaces 71 opposite to each other in the axial direction (A) and mounted respectively with two anchoring rings 75 thereon, and an outer annular surface 72. The outer annular surface 72 is formed with a plurality of inwardly and radially extending slots 77 spaced apart from each other and angularly equidistant. In this embodiment, the rotor 7 includes two first rotor sections 73 opposite to each other in the axial direction (A), and a second rotor section 74 interconnecting the first rotor sections 73 and formed with the slots 77 (see FIG. 8). Each of the first and second rotor sections 73, 74 consists of a plurality of silicon steel pieces (not shown). Each first rotor section 73 has a corresponding end surface 71. In this embodiment, as shown in FIGS. 9 and 10, the end surface 71 of each first rotor section 73 is formed with two air holes 76 spaced angularly apart from each other and extending in the axial direction (A). Each air hole 76 in each first rotor section 73 is in spatial communication with corresponding slots 77. In addition, the outer annular surface 72 of the rotor 7 is formed with a plurality of winding grooves 78 spaced angularly apart from each other and extending in the axial direction (A) through the first rotor sections 73 and through the second rotor section 74, as shown in FIGS. 7 and 8. It is noted that each winding groove 78 in the rotor 7 is disposed between a corresponding adjacent pair of the slots 77 in the second rotor section 74, as shown in FIG. 8.

When the rotor 7 rotates, each through hole 65 in the stator 6 is successively in spatial communication with the slots 77 in the rotor 7. As a result, heated air in the rotor 7 can flow from the air holes 76 in the first rotor sections 73 to the air grooves 416 of the air-flow space 40 through the slots 77 in the second rotor section 74 and through the through holes 65 in the stator 6, thereby transferring heat from the rotor 7 to the motor housing 4. In the same time, heat from the stator 6 is also transferred to the motor housing 4. Then, heat accumulated in the motor housing 4 can be effectively dissipated through flow of the cooling fluid through the fluid-flow channel 411 using an external heat exchanger (not shown). Therefore, the electric motor of the present invention can attain an improved heat dissipation effect.

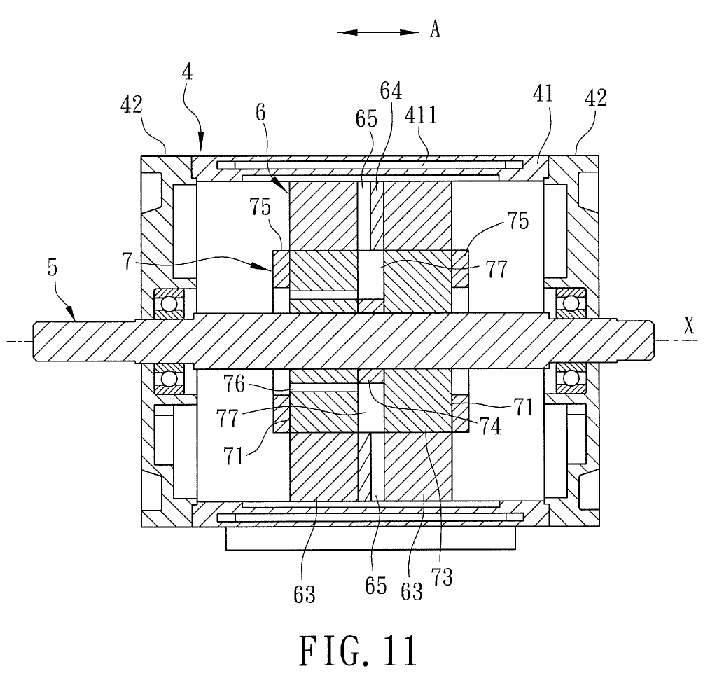

FIG. 11 illustrates a variation of the first preferred embodiment, wherein a left one of the end surfaces 71 of the rotor 7 is formed with two air holes 76 that extend through the left first rotor section 73. In addition, the winding grooves extend through the left first rotor section 73 and the second rotor section 74.

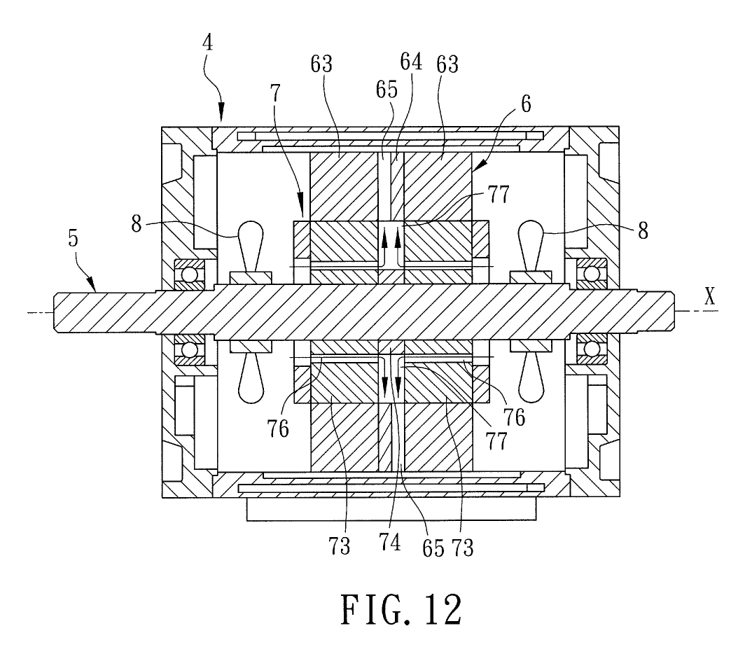

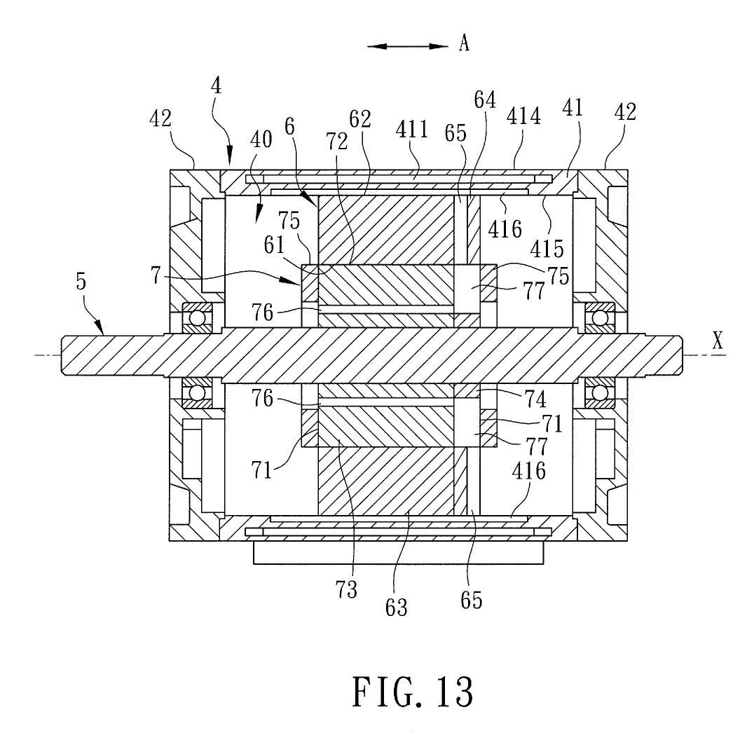

FIG. 12 illustrates the second preferred embodiment of an electric motor according to this invention, which is a modification of the first preferred embodiment. In this embodiment, the electric motor further includes two fan impellers 8 disposed in the motor housing 4, mounted on the motor shaft 5 and co-rotatable with the motor shaft 5. In use, the fan impellers rotate with the motor shaft 5 such that each fan impeller 8 generates airflow with a wind pressure that forces heated air in a corresponding first rotor section 73 to flow from the air holes 76 in the corresponding first rotor section 73 to the air grooves 416 through the slots 77 in the second rotor section 74 and through the through holes 65 in the stator 6.

FIG. 13 illustrates the third preferred embodiment of an electric motor according to this invention, which is a modification of the first preferred embodiment. Unlike the first preferred embodiment, the stator 6 has only one first stator section 63 connected to the second stator section 64. In addition, the rotor 7 has only one single first rotor section 73 connected to the second rotor 74. Each of the first and second rotor sections 73, 74 has a corresponding end surface 71 of the rotor 7 that is mounted with a corresponding anchoring ring 75 thereon.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electric motor comprising:
a motor housing including a tube body, said tube body being formed with an annular fluid-flow channel adapted for receiving cooling fluid therein, and an inlet and an outlet in spatial communication with said fluid-flow channel, and having opposite inner and outer annular surfaces;
a motor shaft mounted rotatably within said motor housing and rotatable relative to said motor housing about a central axis of said tube body;
a stator mounted fixedly in said motor housing, disposed around said motor shaft, and cooperating with said tube body to define an air-flow space therebetween, said stator having an inner annular surface and an outer surrounding surface, and being formed with at least one through hole extending radially from said inner annular surface to said outer surrounding surface and in spatial communication with said air-flow space; and
a rotor sleeved fixedly on said motor shaft such that said motor shaft co-rotates with said rotor, said rotor having two end surfaces opposite to each other in an axial direction parallel to the central axis, and an outer annular surface, said outer annular surface of said rotor being formed with a plurality of inwardly and radially extending slots spaced angularly apart from each other, at least one of said end surfaces of said rotor being formed with a plurality of air holes spaced angularly apart from each other and extending in the axial direction, each of said air holes in said rotor being in spatial communication with at least a corresponding one of said slots;
wherein, when said rotor rotates, said through hole in said stator is successively in spatial communication with said slots in said rotor.

2. The electric motor as claimed in claim 1, wherein said air-flow space includes at least one air groove formed in said inner annular surface of said tube body of said motor housing, extending in the axial direction and in spatial communication with said through hole in said stator.

3. The electric motor as claimed in claim 2, wherein said air groove in said tube body of said motor housing has a length longer than that of said stator in the axial direction.

4. The electric motor as claimed in claim 1, wherein said rotor includes:
at least one first rotor section formed with said air holes; and
a second rotor section connected to said first rotor section and formed with said slots.

5. The electric motor as claimed in claim 4, wherein:
said outer annular surface of said rotor is formed with a plurality of winding grooves spaced angularly apart from each other and extending in the axial direction through said first rotor section and through said second rotor section; and
each of said winding grooves is disposed between a corresponding adjacent pair of said slots in said second rotor section.

6. The electric motor as claimed in claim 1, wherein said rotor includes:
two first rotor sections opposite to each other in the axial direction, each of said first rotor sections having a corresponding one of said end surfaces, at least one of said first rotor sections being formed with said air holes; and
a second rotor section interconnecting said first rotor sections and formed with said slots.

7. The electric motor as claimed in claim 6, wherein:
said outer annular surface of said rotor is formed with a plurality of winding grooves spaced angularly apart from each other and extending in the axial direction through at least one of said first rotor sections and through said second rotor section; and
each of said winding grooves is disposed between a corresponding adjacent pair of said slots in said second rotor section.

8. The electric motor as claimed in claim 1, wherein said stator includes:
at least one first stator section; and
a second stator section connected to said first stator section and formed with said through hole.

9. The electric motor as claimed in claim 8, wherein said inner annular surface of said stator is formed with a plurality of winding grooves spaced angularly apart from each other and extending in the axial direction through said first stator sections and through said second stator section.

10. The electric motor as claimed in claim 8, wherein said stator includes two said first stator sections opposite to each other in the axial direction so that said second stator section interconnects said first stator sections.

11. The electric motor as claimed in claim 1, further comprising at least one fan impeller disposed in said motor housing, mounted on said motor shaft and co-rotatable with said motor shaft.
